(19) United States
(12) Patent Application Publication
(10) Pub. No.: US 2025/0038838 A1
(43) Pub. Date: Jan. 30, 2025

(54) Frequency-shift Symmetric Chirp Spread Spectrum Modulation and Demodulation Method for Interstellar Communication Links

(71) Applicant: ZHEJIANG UNIVERSITY, Hangzhou (CN)

(72) Inventors: Xiaofeng JIN, Hangzhou (CN); Jie LI, Hangzhou (CN); Xiangdong JIN, Hangzhou (CN); Jijun ZOU, Hangzhou (CN); Bing WEI, Hangzhou (CN)

(21) Appl. No.: 18/361,380

(22) Filed: Jul. 28, 2023

(51) Int. Cl. H04B 7/185; H04B 1/7075

(52) U.S. Cl. CPC H04B 7/18521; H04B 1/7075; H04B 2001/6912

(57) ABSTRACT

A frequency-shift symmetric chirp spread spectrum modulation and demodulation method for interstellar communication links. The transmission process includes several steps: serial-to-parallel conversion, index addition, Gray coding, binary-to-decimal conversion, and frequency-shift symmetric chirp spread spectrum modulation. On the other hand, the reception process comprises demodulation of the symmetric chirp signal, fast Fourier transform, peak retrieval, decimal-to-binary conversion, Gray decoding, index removal, and parallel-to-serial conversion. The frame structure includes a preamble code, synchronization word, and user data. The symmetric chirp signal includes a pair of chirp signals with opposite polarities, ensuring the continuity of phase and frequency during the signal concatenation process. Compared to traditional chirp signals, the symmetric chirp signal exhibits superior correlation characteristics, enhanced noise resistance, and improved Doppler tolerance, making it particularly suitable for interstellar communication links.

### FIELD OF THE DISCLOSURE

The present invention relates to the field of communication technology, and especially to a frequency-shift symmetric chirp spread spectrum modulation and demodulation method for interstellar communication links.

### BACKGROUND OF THE DISCLOSURE

At the current stage, many regions lack full coverage of ground-based mobile cellular networks, necessitating satellite communication networks as a supplement to provide basic communication services in these areas. Compared to ground-based cellular networks, satellite communication networks face greater transmission link losses due to the relatively distant distances. They are also affected by rain fade, which further deteriorates the noise performance of the receiving link. Moreover, satellites maintain relatively high relative velocities to maintain their orbital paths, leading to Doppler effects that cause significant frequency shifts between transmission and reception loops. As communication frequencies increase, Doppler effects can result in even larger frequency shifts.

Frequency-shift chirp spread spectrum modulation (FSCM) is a variant of chirp spread spectrum (CSS) technology. Due to the insensitivity of chirp spread spectrum to frequency offsets, FSCM exhibits strong resistance to Doppler frequency shifts, interference, and high receiving sensitivity. It has been applied in the modulation and demodulation processes of the LoRa communication protocol. FSCM modulates information as frequency shift values in chirp signals. Chirp signals with different frequency shift values constitute mutually orthogonal chirp code chips. The receiving end obtains the frequency shift component by multiplying the received signal by chirp signals with opposite polarities. This results in a single-tone signal with a frequency equal to the frequency shift value. By performing Fourier transform and peak detection on this signal, the frequency shift value is obtained. Because information is modulated as relative frequency shift values, fixed frequency shift biases introduced by Doppler effects between transmission and reception can be easily detected and eliminated.

Although FSCM exhibits excellent resistance to Doppler effects, its chirp code chips have weaker correlation compared to other spread spectrum technologies like direct sequence spread spectrum. Therefore, when the data throughput and data rate are high, its noise resistance performance is not as strong as other spread spectrum methods. In recent years, researchers have proposed a method called PSK-LoRa, which combines frequency-shift chirp spread spectrum with phase modulation.

By modulating some data as the initial phase of frequency-shift chirp signals, higher data throughput can be achieved. However, this approach requires coherent demodulation of the initial phase at the receiver, adding complexity to the equipment. Considering the complexity of the receiving demodulation algorithm, some scholars have proposed the use of IQCSS (In-Phase and Quadrature Phase Shift Keying)-LoRa, where chirp spread spectrum modulation signals are transmitted simultaneously through in-phase and quadrature components. While this approach increases spectrum efficiency, it sacrifices the system's noise resistance performance.

Given the characteristics of satellite communication, exploring communication methods that are insensitive to Doppler frequency shifts and have strong noise resistance has become a recent research focus.

### SUMMARY OF THE DISCLOSURE

Given the foregoing, this invention presents a method of frequency-shift symmetric chirp spread spectrum modulation and demodulation tailored for interstellar communication links. This method preserves the excellent characteristics of the frequency-shift chirp spread spectrum in resisting Doppler frequency shifts and more. Moreover, it fortifies the signal's correlation performance through symmetric chirp modulation, thereby enhancing the system's resistance to noise.

The invention offers a frequency-shift symmetric chirp spread spectrum modulation and demodulation method designed for interstellar communication links. The method involves dividing the input information bits into R blocks of depth SF, based on the spreading factor SF and the number of branches R. The high M bits of each block serve as the branch index code, where M is log₂R. After Gray coding, each block is represented as decimal information, denoted as di. These information blocks are used to modulate the original symmetrical chirp signal with a relative frequency shift of (dᵢ·Bw/2^{SF}), where Bw represents the chirp signal's transmission bandwidth. The resulting modulated signals for each information block are denoted as Sᵢ. The R signals corresponding to R information blocks are linearly combined and transmitted through the channel.

The symmetric chirp signal is composed of a pair of chirp signals with opposite polarities, classified into upward chirp signal and downward chirp signal based on their frequency variation rates. The upward chirp signal has a positive frequency variation rate, resulting in an increase in instantaneous frequency, while the downward chirp signal has a negative frequency variation rate, resulting in a decrease in instantaneous frequency. The symmetric chirp signal is formed by concatenating one upward chirp signal and one downward chirp signal, and based on their arrangement, it can be categorized into two types: positive symmetric chirp signal, where the upward chirp signal precedes the downward chirp signal, and negative symmetric chirp signal, where the downward chirp signal precedes the upward chirp signal. The frequency variation rates of the upward and downward chirp signals are mutually opposite, and their frequency variation ranges are both from −Bw/2 to Bw/2.

The concatenation process of the upward and downward chirp signals in the symmetric chirp signal ensures the continuity of the instantaneous frequency, meaning that the ending frequency of the upward chirp signal within one chirp cycle is equal to the starting frequency of the downward chirp signal, and vice versa. The concatenation process also guarantees phase continuity, meaning that the ending phase of the upward chirp signal within one chirp cycle is equal to the starting phase of the downward chirp signal, and vice versa.

The frequency shift process of the symmetric chirp signal involves a cyclic shift in instantaneous frequency, ensuring the continuity of phase and instantaneous frequency during the frequency shift. In this process, the instantaneous frequency experiences jumps when reaching the boundary of the frequency variation range, transitioning from Bw/2 to −Bw/2 or from −Bw/2 to Bw/2. For a positive symmetric chirp signal with a frequency shift of Δf, its frequency will vary linearly in the following order: (−Bw/2+Δf) to (Bw/2), (−Bw/2) to (−Bw/2+Δf), (−Bw/2+Δf) to (−Bw/2), and (Bw/2) to (−Bw/2+Δf). For a negative symmetric chirp signal with a frequency shift of Δf, its frequency will vary linearly in the following order: (−Bw/2+Δf) to (−Bw/2), (Bw/2) to (−Bw/2+Δf), (−Bw/2+Δf) to (Bw/2), and (−Bw/2) to (−Bw/2+Δf).

The reception process involves consecutive steps of demodulation of the received signal through symmetric chirp processing, fast Fourier transform, peak detection in the frequency domain, information decoding, and reassembly.

In the reception process, the demodulation of the received signal involves multiplying the signal by a symmetric chirp signal with opposite polarity to obtain the relative frequency shift (dᵢ·Bw/2^{SF}). If the modulation used during transmission is positive symmetric chirp signal, the demodulation employs negative symmetric chirp signal, and vice versa if the modulation is negative symmetric chirp signal during transmission.

Furthermore, the signal after demodulation with symmetric chirp includes a combination of trigonometric functions with a frequency of (dᵢ·Bw/2^{SF}) in the form of relative frequency shift. By applying fast Fourier transform, the frequency domain characteristics are obtained. The relative frequency shift is then determined based on the peak position in the frequency domain of the demodulated signal. Consequently, the decimal information dᵢ for each information block is computed. Finally, the information bits are reconstructed by concatenating R information blocks based on the index code located in the high M bits of each block.

The transmission and reception process employs a frame structure including a preamble, sync word, and user data. The number of preambles is denoted as Npre, the number of sync words is denoted as Nsync, and the number of user data symbols is denoted as Ndata. Npre and Nsync are mutually agreed upon by the transmitting and receiving parties, while Ndata is determined by the burst user data packet length.

The preamble in the frame structure is formed by a sequence of continuous positive and negative symmetric chirp signals. Specifically, when positive symmetric chirp signals are used for transmission modulation and negative symmetric chirp signals are used for reception demodulation, the preamble includes Npre continuous positive symmetric chirp signals without any frequency shift modulation, followed by Nsync continuous negative symmetric chirp signals without any frequency shift modulation. Conversely, when negative symmetric chirp signals are used for transmission modulation and positive symmetric chirp signals are used for reception demodulation, the preamble includes Npre continuous negative symmetric chirp signals without any frequency shift modulation, followed by Nsync continuous positive symmetric chirp signals without any frequency shift modulation.

On the other hand, the user data includes Ndata symbols, and each symbol is the linear combination of R-channel frequency-shift symmetric chirp signals.

The frame structure introduces a preamble to achieve rapid Doppler frequency offset correction and time synchronization between the transmitter and receiver. The preamble includes unmodulated symmetric chirp signals, serving to eliminate frequency and time offsets. Its distinctive feature lies in performing demodulation of the preamble using symmetric chirp signals and applying fast Fourier transform to estimate frequency and time offsets through the average and difference of frequency components in the spectrum.

Moreover, the frame structure incorporates a sync word to separate the preamble from user data. By using a sync word including symmetric chirp signals with opposite polarities to the preamble, the receiver can efficiently locate the sync word using positive and negative scans and achieve separation of the preamble and user data. The positive and negative scan method involves demodulating the received signal first with a positive symmetric chirp signal to obtain the forward scan spectrum using fast Fourier transform. Subsequently, demodulating the received signal with a negative symmetric chirp signal yields the reverse scan spectrum. By analyzing the differences between the forward and reverse scan spectra, the sync word is accurately positioned, enabling the receiver to distinguish between the preamble and user data within the received frame.

### BRIEF DESCRIPTION OF DRAWINGS

FIG. 1A is a schematic diagram showing the transmitting end according to embodiments of the present invention.

FIG. 1B a schematic diagram showing the receiving end according to embodiments of the present invention.

FIG. 2 is a frame structure according to embodiments of the present invention.

FIG. 3A is a diagram showing the instantaneous frequency variation of the symmetric chirp signal over time.

FIG. 3B shows the phase variation of the symmetric chirp signal over time.

FIG. 3C displays the amplitude variation of the symmetric chirp signal over time.

FIG. 4A shows the instantaneous frequency variation of the symmetric chirp signal after frequency shift over time.

FIG. 4B shows the phase variation of the symmetric chirp signal after frequency shift over time.

FIG. 4C shows the amplitude variation of the symmetric chirp signal after frequency shift over time.

FIG. 5A shows the ambiguity function of the chirp signal.

FIG. 5B shows the ambiguity function of the symmetric chirp signal.

In the drawings: 101-Serial-to-Parallel Conversion; 102-Index Addition; 103-Gray Encoding; 104-Binary to Decimal Conversion; 105-Frequency Shift Amount Calculation; 106-Frequency Shifted Symmetric Chirp Signal Modulation; 107-Linear Combination; 108-Transmitting Antenna; 201-Parallel-to-Serial Conversion; 202-Index Removal; 203-Gray Decoding; 204-Decimal to Binary Conversion; 205-Peak Retrieval; 206-Fast Fourier Transform; 207-Chirp Signal Demodulation; 208-Receiving Antenna.

### DETAILED DESCRIPTION OF THE DISCLOSURE

In order to describe the present invention more specifically, the technical solutions of the present invention will be described in detail below in conjunction with the accompanying drawings and specific embodiments.

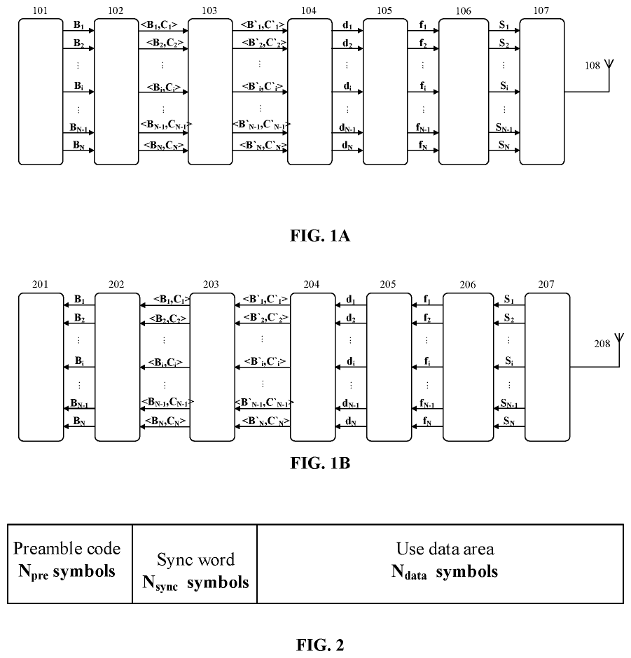

As shown in FIGS. 1A and 1B, the schematic diagram illustrates a method for frequency-shift symmetric chirp spread spectrum (CSS) modulation and demodulation, specifically designed for interstellar communication links. The modulation process is governed by key parameters, including the spreading factor (SF), transmission bandwidth (Bw), and the number of branches (R), with M defined as log₂R and N as 2^{SF}.

As shown in FIG. 1A, the transmission process at the sender's end includes the following steps:
1. Serial-to −parallel conversion: The input bitstream is divided into R equal-length information blocks, considering the spreading factor and the number of branches. Each information block has a length of (SF-M), as depicted in Equation (1). Here, Bᵢ represents the i-th information block, and b_{i,j} represents the j-th bit of the i-th information block. The values of i range from 1 to R, and the values of j range from 1 to (SF-M).

$${B}_{i} = \{ {b}_{i , 1} , {b}_{i , 2} , … , {b}_{i , j} , … , {b}_{i , SF - M} \} \qquad ( 1 )$$

2. Index addition: The binary representation of the information block index i is used as the index code Cᵢ, which is concatenated with the information code Bᵢ from the information block. During concatenation, the index code Cᵢ comes first, followed by the information code Bᵢ, as depicted in Equation (2).

$$< {C}_{i} , {B}_{i} > = \{ {c}_{i , 1} , {c}_{i , 2} , … , {c}_{i , M} , {b}_{i , 1} , {b}_{i , 2 ,} … , {b}_{i , j} , … , {b}_{i , SF - M} , \} \qquad ( 2 )$$

3. Gray encoding: The information block <Cᵢ, Bᵢ>undergoes Gray encoding, resulting in the encoded information block <Cᵢ′, Bᵢ′>.

$$< {C}_{i}^{′} , {B}_{i}^{′} >= \{ {c}_{i , 1}^{′} , {c}_{i , 2}^{′} , … , {c}_{i , M}^{′} , {b}_{i , 1}^{′} , {b}_{i , 2}^{′} , … , {b}_{i , j}^{′} , {b}_{i , SF - M}^{′} \} \qquad ( 3 )$$

4. Base conversion: The encoded information block <Cᵢ′, Bᵢ′>undergoes base conversion, resulting in the decimal representation dᵢ.

$${d}_{i} = {c}_{i , 1}^{′} , \cdot {2}^{S F - 1} + … + {c}_{i , M}^{′} \cdot {2}^{S F - M} + {b}_{i , 1}^{′} \cdot {2}^{S F - M - 1} + .. + {b}_{i , SF - M}^{′} \qquad ( 4 )$$

5. Frequency shift calculation: The frequency shift ηᵢ of the signal is computed based on the converted decimal representation dᵢ.

$${f}_{i} = \frac{{d}_{i}}{N} \cdot Bw \qquad ( 5 )$$

6. Modulate the symmetric chirp signal with the relative frequency shift ƒᵢ, resulting in the frequency-shifted signal sᵢ(n) as shown in equation (6).

$${s}_{i} ( n ) = \{ \begin{matrix}{e}^{j 2 π \frac{{d}_{i}}{N} n} \cdot {e}^{j π \frac{µ {n}^{2}}{N} n} & , 0 \leq n < N \\ {e}^{j 2 π \frac{{d}_{i}}{N} \cdot ( n - N )} \cdot {e}^{- j π \frac{µ {( n - N )}^{2}}{N} n} & , N \leq n < 2 N\end{matrix} \qquad ( 6 )$$

Where μ represents the polarity of the symmetric chirp signal, and μ=+1 indicates a positive-symmetric chirp signal, while μ=−1 indicates a negative-symmetric chirp signal.
7. Linear Superposition: The frequency-shifted signals are linearly superimposed and transmitted. The final signal, denoted as

$$\frac{1}{\sqrt{R}} \cdot {s}_{i} ( n ) ,$$

is obtained through this process, as shown in equation (7).

$$S ( n ) = {\sum }_{i = 1}^{R} \frac{1}{\sqrt{R}} \cdot {s}_{i} ( n ) \qquad ( 7 )$$

As shown in FIG. 1B, the process of the receiving end is as follows.
1. Demodulation of Symmetric Chirp: At the receiver end, the received signal is multiplied with a symmetric chirp signal of opposite polarity, as depicted in equation (8).

$${S}_{r} ( n ) = \{ \begin{matrix}\{ S ( n ) + e ( n ) \} \cdot {e}^{j π \frac{- µ {n}^{2}}{N}} & , 0 \leq n < N \\ \{ S ( n ) + e ( n ) \} \cdot {e}^{j π \frac{µ {( n - N )}^{2}}{N}} & , N \leq n < 2 N\end{matrix} \qquad ( 8 )$$

Where, e(n) represents signal noise.
2. Fast Fourier Transform: The signal obtained after resolving the symmetric chirp can be further simplified to equation (9).

$${S}_{r} ( n ) = {e}^{j 2 π \frac{{d}_{i}}{N} n} \qquad ( 9 )$$

3. Performing peak detection on the results of the Fast Fourier Transform yields the frequency ηᵢ at the peak positions. By utilizing equation (5), we can then calculate the decimal value dᵢ.
4. Conversion of Base: Transform the decimal value dᵢ into <C′, Bᵢ′>.
5. Gray Decoding yields <Cᵢ, Bᵢ>.
6. By using the index code Cᵢ, concatenate the multi-channel information Bᵢ, and then restore the input information bits.

During the actual communication process, the receiver needs to eliminate the influence of time offset Δt and frequency offset Δf when capturing the signal. This method employs symmetric chirp signals as the preamble to achieve signal acquisition, as illustrated in FIG. 2. The frame structure adopted by this method mainly includes the preamble, synchronization word, and user data. The preamble include Npre symbols, where Npre can vary from 4 to 65536, as specifically defined by the user. The preamble employs symmetric chirp signals with the same modulation polarity as the one used in the modulation process. On the other hand, the synchronization word comprises Nsync symbols, where Nsync can be set to 1 or 2, as defined by the user. The synchronization word uses symmetric chirp signals with the opposite modulation polarity to that employed in the modulation process.

The purpose of the preamble is to facilitate the fast estimation of frequency offset during demodulation, while the synchronization word serves to differentiate between the preamble and the user data area, achieving demodulation synchronization in terms of time.

$$m 1 = Δ t \cdot {f}_{s} \qquad ( 10 )$$

$$m 2 = \frac{Δ f}{B w} \qquad ( 11 )$$

During the communication process, time offset leads to a lag in the sampling points, and frequency offset introduces an inherent frequency difference, as depicted in equations (10) and (11). The impact of time offset and frequency offset on the system can be quantified using m1 and m2, respectively. The expression for the received signal is given by equation (12).

$${s}_{i} ( n ) = \{ \begin{matrix}{e}^{j 2 π \frac{{d}_{i}}{N} ( n - {m}_{1} )} \cdot {e}^{j π \frac{µ {( n - {m}_{1} )}^{2}}{N}} \cdot {e}^{j 2 π ( n - {m}_{1} ) {m}_{2}} & , 0 \leq n < N \\ {e}^{j 2 π \frac{{d}_{i}}{N} ( n - {m}_{1} - N )} \cdot {e}^{- j π \frac{µ {( n - {m}_{1} - N )}^{2}}{N}} \cdot {e}^{j 2 π ( n - {m}_{1} ) {m}_{2}} & , N \leq n < 2 N\end{matrix} \qquad ( 12 )$$

Then, the signal obtained after resolving the symmetric chirp is represented by equation (13).

$${S}_{r} ( n ) = \{ \begin{matrix}{e}^{j 2 π \frac{{d}_{i} - µ \cdot {m}_{1} + {m}_{2} \cdot N}{N} n} & , 0 \leq n < N \\ {e}^{j 2 π \frac{{d}_{i} - µ \cdot {m}_{1} + {m}_{2} \cdot N}{N} n} & , N \leq n < 2 N\end{matrix} \qquad ( 13 )$$

Therefore, the signal components k1 and k2 contained in the Fourier Transform are given by equations (14) and (15), respectively, where the decimal value dᵢ in the preamble is set to 0.

$$k 1 = - μ \cdot {m}_{1} + {m}_{2} \cdot N \qquad ( 14 )$$

$$k 2 = μ \cdot {m}_{1} + {m}_{2} \cdot N \qquad ( 15 )$$

The frequency offset m1 and time offset m2 can be estimated from k1 and k2.

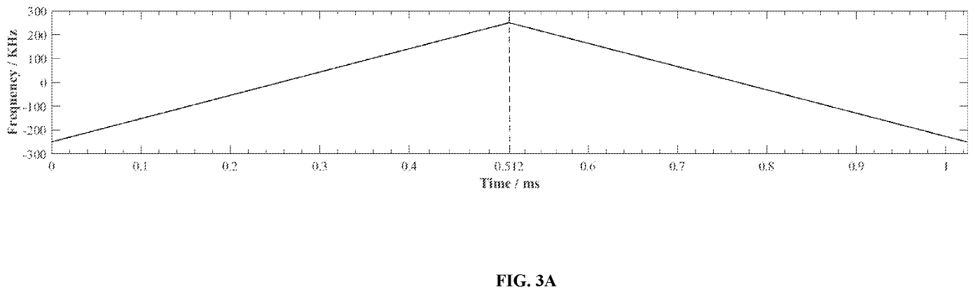

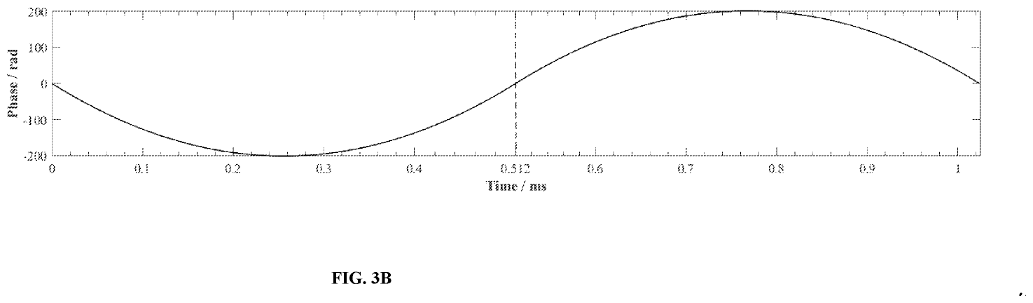

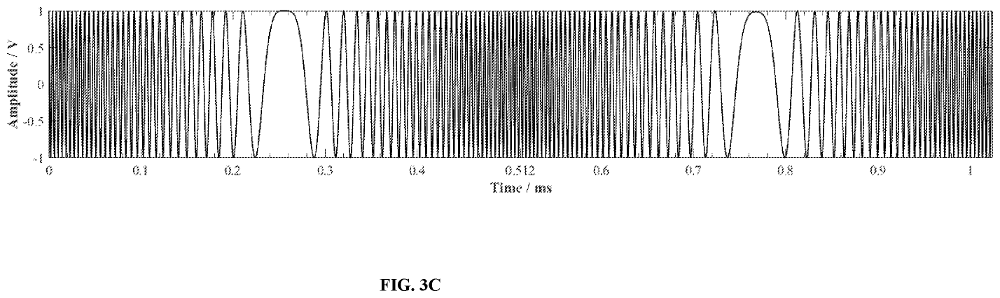

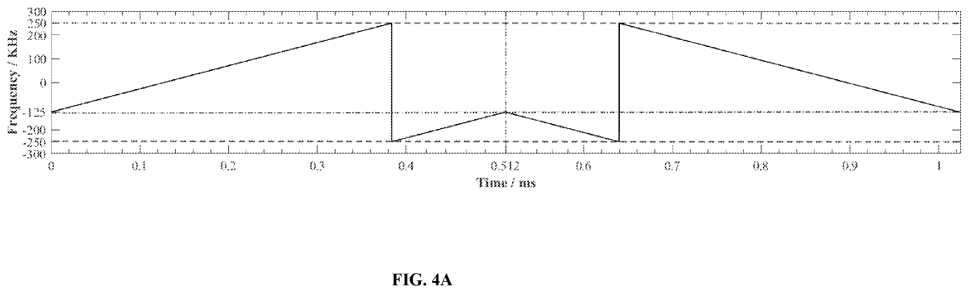

As shown in FIGS. 3A and 3B, the symmetric chirp signal is formed by concatenating an upward chirp signal and a downward chirp signal. The dashed line represents the continuity of instantaneous frequency and phase at the concatenation moment.

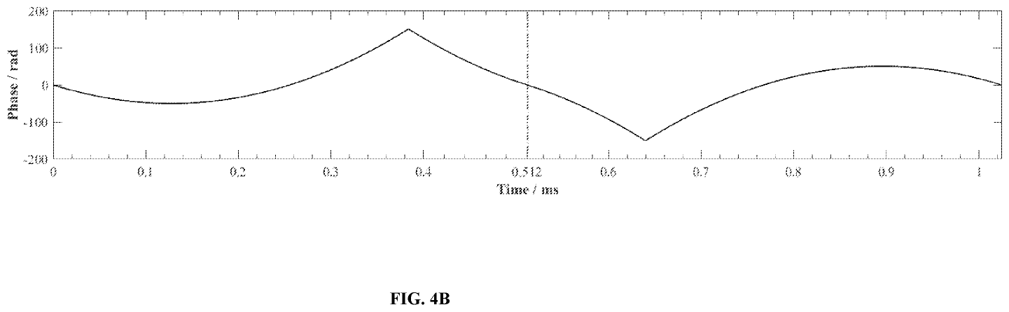

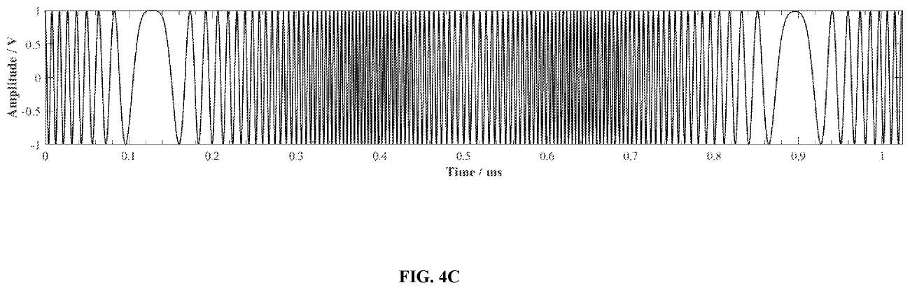

In FIGS. 4A and 4B, the frequency shift of the symmetric chirp signal corresponds to a cyclic shift of the instantaneous frequency. When the instantaneous frequency reaches Bw/2, it will abruptly change to −Bw/2 at the next moment, and vice versa. This approach also ensures the continuity of the instantaneous frequency and phase after the frequency shift during concatenation.

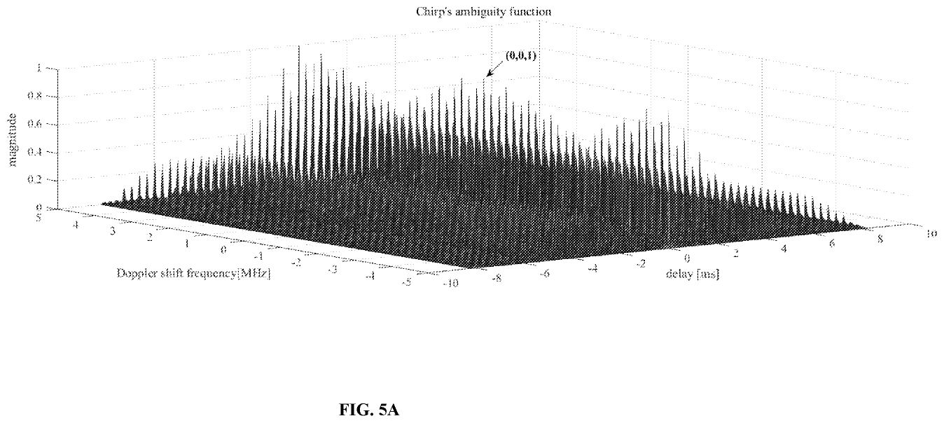

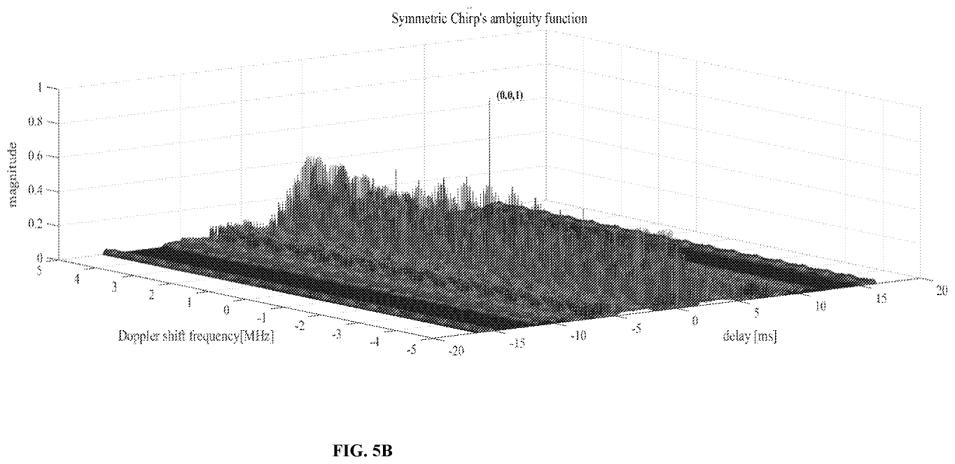

FIG. 5A shows the ambiguity function plot of the chirp signal, while FIG. 5B shows the ambiguity function plot of the symmetric chirp signal. The x-axis represents the time delay, the y-axis represents the Doppler frequency shift, and the z-axis indicates the correlation coefficient.

In FIG. 5A, besides reaching the maximum correlation of 1 at the position of zero time delay and zero Doppler frequency shift, there are still many combinations of time delay and Doppler frequency shift that yield correlation coefficients of 1. However, in FIG. 5B, apart from the maximum correlation of 1 at the position of zero time delay and zero Doppler frequency shift, the correlation coefficients obtained at other positions are all less than 0.5.

Based on the definition of the ambiguity function, equation (16) represents the correlation value of the chirp signal at time delay

τ*=ƒ_{d}/μ,

and equation (17) represents the correlation value of the symmetric chirp signal at time delay

τ*=ƒ_{d}/μ.

From the analysis of the ambiguity functions of these two signals, it is evident that the symmetric chirp signal exhibits better correlation properties compared to the chirp signal. Therefore, when capturing the signal, the symmetric chirp signal is less sensitive to frequency offset.

$$\vert A {F}^{c s} ( {τ}^{*} , {f}_{d} ) \vert = 1 - \vert \frac{{f}_{d}}{B w} \vert \qquad ( 16 )$$

$$\vert {AF}^{s c s} ( {τ}^{*} , {f}_{d} ) \vert = 1 - 4 \vert \frac{{f}_{d}}{B w} \vert \qquad ( 17 )$$

Where,

τ*=ƒ_{d}/μ.

The above description of the embodiments is for those of ordinary skill in the art to understand and apply the present disclosure. It is apparently that those skilled in the art may make various modifications to the aforementioned embodiments, and apply the general principles described here to other embodiments without creative efforts. Therefore, the present disclosure is not limited to the above embodiments, and improvements and modifications made by those skilled in the art according to this disclosure should fall within the protection scope of the present invention.

What is claimed is:

1. A frequency shift symmetric chirp spread spectrum modulation and demodulation method for interstellar communication links, comprising
dividing, by a transmitting end, input information bits into R information blocks with a depth of SF according to a spreading factor SF and a branch number R, and using high M bits of the information blocks as index codes of branches, where M=log₂R; the information blocks are encoded by Gray and then represented by decimal information, and a decimal information represented by the i-th information block is defined as dᵢ, where a value range of i is 1-R; the information block uses (dᵢ·Bw/2^{SF}) as a relative frequency shift pair to perform frequency-shift chirp spread-spectrum modulation on an original symmetric chirp signal; where Bw represents a transmission bandwidth of the original symmetric chirp signal, and the frequency-shift symmetric chirp signal modulated by the i-th information block is called Sᵢ; R information blocks corresponding to R frequency-shift symmetric chirp signals are linearly superimposed and transmitted through a channel;
performing, by a receiving end, desymmetric chirp, fast Fourier transform, frequency domain peak retrieval, Gray decoding, deindexing and information block splicing on the signal in sequence to restore the input information bits;
wherein a frame structure used in the sending and receiving process comprises preamble, synchronization word and user data; the number of preamble is Npre, the number of synchronization word is Nsync, and the user data is Ndata; Npre and Nsync are determined by the transmitting and receiving ends, and Ndata is determined by the user data packet length;

2. The method according to claim 1, the symmetric chirp signal comprises a pair of chirp signals with opposite frequency variation rates; based on the polarity of frequency variation rates, the chirp signals are classified into a upward chirp signal and a downward chirp signal; the upward chirp signal has a positive frequency variation rate, with its instantaneous frequency increasing over time, while the downward chirp signal has a negative frequency variation rate, causing instantaneous frequency of the downward chirp signal to decrease over time;
the symmetric chirp signals are arranged in two ways based on the concatenation order of upward and downward chirp signals: if the upward chirp signal precedes the downward chirp signal, it is referred to as the positive symmetric chirp signal; conversely, if the downward chirp signal comes before the upward chirp signal, it is known as the negative symmetric chirp signal.

3. The method according to claim 1, wherein the process of concatenating the upward and downward chirp signals of the symmetric chirp signal ensures the continuity of the instantaneous frequency; within one period of a chirp signal, the ending frequency of the upward chirp signal is equal to the starting frequency of the downward chirp signal, and the starting frequency of the upward chirp signal is equal to the ending frequency of the downward chirp signal.

4. The method according to claim 1, wherein the process of concatenating the upward and downward chirp signals of the symmetric chirp signal ensures the continuity of the phase; within one period of a chirp signal, the ending phase of the upward chirp signal is equal to the starting phase of the downward chirp signal, and the starting phase of the upward chirp signal is equal to the ending phase of the downward chirp signal.

5. The method according to claim 1, wherein the process of concatenating the upward and downward chirp signals requires that the frequency variation rates of the upward and downward chirp signals are opposite to each other and vary linearly within the range of −Bw/2 to Bw/2, where Bw represents the bandwidth;
after frequency shifting, the symmetric chirp signal maintains the continuity of both the inter-signal phase and the instantaneous frequency.

6. The method according to claim 1, wherein the continuity of phase and frequency during the concatenation of the upward and downward chirp signals requires that the frequency shifting process of the symmetric chirp signal is a form of cyclic shift in instantaneous frequency; when the instantaneous frequency reaches the boundary of the frequency range, a jump is generated, transitioning from Bw/2 to −Bw/2 and vice versa, from −Bw/2 to Bw/2;
for a positive symmetric chirp signal with a frequency shift of Δf, the frequency is varied linearly in the following order: (−Bw/2+Δf) to (Bw/2), (−Bw/2) to (−Bw/2+Δf), (−Bw/2+Δf) to (−Bw/2), and (Bw/2) to (−Bw/2+Δf);
for a negative symmetric chirp signal with a frequency shift of Δf, the frequency is varied linearly in the following order: (−Bw/2+Δf) to (−Bw/2), (Bw/2) to (−Bw/2+Δf), (−Bw/2+Δf) to (Bw/2), and (−Bw/2) to (−Bw/2+Δf).

7. The method according to claim 1, wherein during the demodulation process, the receiving end multiplies the received signal by a symmetric chirp signal with opposite polarity; when the transmission employs a positive symmetric chirp signal for modulation, the receiving end uses a negative symmetric chirp signal for demodulation, and vice versa.

8. The method according to claim 1, wherein the demodulated signal after symmetrical chirp demodulation is subjected to a Fast Fourier Transform to obtain its frequency domain characteristics; based on the peak positions in the frequency domain, the relative frequency shift is determined and converted into decimal information, represented as dᵢ; after Gray decoding the decimal information dᵢ, the resulting information code Bᵢ is used, taking high M bits as an index to concatenate the information for the R channels.

9. The method according to claim 1, wherein the preamble code uses an unmodulated symmetric chirp signal with the same polarity as the modulated symmetric chirp signal during transmission; the synchronization word employs an unmodulated symmetric chirp signal with the same polarity as the demodulated symmetric chirp signal during reception; if the modulation signal is a positive symmetric chirp signal and the demodulation signal is a negative symmetric chirp signal, the preamble code will be a positive symmetric chirp signal, and the synchronization word is a negative symmetric chirp signal, and vice versa; the user data is a linear combination of the R channels' frequency-shift symmetric chirp signals.

10. The method according to claim 1, wherein the synchronization word uses a symmetric chirp signal with the opposite polarity of the preamble code; during reception, fast positioning of the synchronization word is achieved through forward and reverse scanning; the forward scanning spectrum is obtained by demodulating the received signal using a positive symmetric chirp signal and then applying Fast Fourier Transform; the reverse scanning spectrum is obtained by demodulating the received signal using a negative symmetric chirp signal and then applying Fast Fourier Transform; by analyzing the differences between the forward and reverse scanning spectra, the synchronization word is located, allowing for the separation of the preamble code and user data based on the position of the synchronization word.
